(19) United States
(12) Patent Application Publication
(10) Pub. No.: US 2022/0051347 A1
(43) Pub. Date: Feb. 17, 2022

(54) METHOD FOR DISCLOSING MUTUAL FEELINGS AND USE THEREOF

(71) Applicant: OLEKSII VASYLENKO, Kyiv (UA)

(72) Inventor: OLEKSII VASYLENKO, Kyiv (UA)

(21) Appl. No.: 17/330,759

(22) Filed: May 26, 2021

Related U.S. Application Data
(60) Provisional application No. 63/065,528, filed on Aug. 14, 2020.

(51) Int. Cl. G06Q 50/00; G06Q 30/02; G06Q 20/12; H04L 29/06; H04L 29/08

(52) U.S. Cl. CPC G06Q 50/01; G06Q 30/0277; H04L 67/26; H04L 63/0414; H04L 67/20; G06Q 20/123

(57) ABSTRACT

Disclosed is a method for disclosing mutual feelings, including receiving, by a processing unit (PU), one or more data about a first user from a first user device associated with the first user; selecting, by the first user, a second user associated with the first user; selecting, by the first user, a first feeling, from a plurality of feelings, wherein the first feeling is indicative of how the first user feels toward the second user, and transmitting, by the PU, a first notification to a second user device associated with the second user, wherein the first notification is so transmitted that an identity of the first user is not revealed.

### CROSS REFERENCE TO THE RELATED APPLICATIONS

This application is based upon and claims priority to U.S. Provisional Application No. 63/065,528, filed on Aug. 14, 2020, the entire contents of which are incorporated herein by reference.

### TECHNICAL FIELD

The present invention relates to the technical field of networking, and more specifically to a method for disclosing mutual feelings and use thereof.

### BACKGROUND

Social networks enable people to connect. However, the social networks and applications lack the logic of secret crash, in which people do not reveal their feelings toward each other.

### SUMMARY

In view of the problems described above, the present invention provides a method for disclosing mutual feelings and use thereof. The present invention adopts the following technical solutions: receiving, by a processing unit (PU), one or more data about a first user from a first user device associated with the first user; selecting, by the first user, a second user associated with the first user; selecting, by the first user, a first feeling, from a plurality of feelings, wherein the first feeling is indicative of how the first user feels toward the second user, and transmitting, by the PU, a first notification to a second user device associated with the second user, wherein the first notification is so transmitted that an identity of the first user is not revealed.

In some embodiments, the method includes prior to transmitting the first notification to the second user device, adding, by the first user, one or more prompts to the first feeling. The one or more prompts includes at least one of: a phone number associated with the first user, a zodiac sign associated with the first user, an eye color associated with the first user, a city of residence associated with the first user, and a favorite music associated with the first user. The one or more prompts are locked for the second user. In some embodiments, the second user watches a paid advertisement associated with a third-party to unlock the prompt. In some embodiments, the second user pays to unlock the prompt.

In some embodiments, selecting a second user includes accessing a contact list of the first device, and selecting the second user from the contact list. In some embodiments, the method further includes upon a selection of the second user, providing, by the first user, one or more information associated with the second user. The one or more information associated with the second user may include at least one of: a first name of the second user, a surname of the second user, and a phone number associated with the second user. In some embodiments, the method includes, upon a determination that at least one of the one or more information associated with the second user is incorrect, editing, by the first user, the at least one of the one or more information associated with the second user, and updating, by the PU, the contact list, by replacing the at least one of the one or more information associated with the second user with the edited at least one of the one or more information associated with the second user. The one or more data about a first user include personal information of the first user. The personal information of the first user may include at least one of: a first name of the first user, a surname of the first user, a date of birth of the first user, a sex of the first user, a city of residence of the first user, a height of the first user, an eye color of the first user, a hobby of the first user, and a place of work of the first user.

In some embodiments, transmitting the first notification to the second user device is so performed that the first feeling is not revealed to the second user. The PU may be located on a remote server. The method may be performed on an application program interface (API) on the first user device.

In some embodiments, a phone number associated with the first user is used to identify the first user. According to some embodiments, the plurality of feelings includes one or more feelings indicative of at least one of: sympathy, love, sexual desire, breakup, reconciliation, and marriage proposal.

In some embodiments, the method further includes upon receiving the first notification by the second user device, selecting, by the second user, a third user associated with the second user; selecting, by the second user, a second feeling, from a plurality of feelings, wherein the second feeling is indicative of how the second user feels toward the third user; upon determinations, by the PU, that the second user is a same as the third user, and the first feeling is a same as the second feeling, transmitting, by the PU, a second notification to the first user device and the second user device, wherein the second notification is indicative of the first feeling.

In some embodiments, the method includes prompting the first user and the second user to communicate via at least one of: the API, and a third-party user device application. In some embodiments, the method includes, upon a determination, by the PU, that the second user is not same as the third user, transmitting, by the PU, a third notification to the third user, wherein the third notification is so transmitted that an identity of the second user is not revealed.

### BRIEF DESCRIPTION OF THE DRAWINGS

So that the present disclosure can be understood by those of ordinary skill in the art, a more detailed description can be had by reference to aspects of some illustrative embodiments, some of which are shown in the accompanying drawings.

FIG. 1 illustrates a schematic of the method for disclosing mutual feelings, in accordance with some embodiments.

FIG. 2 illustrates a schematic of the method for disclosing mutual feelings, in accordance with some embodiments.

FIGS. 3A & 3B illustrate schematics of the mobile application to implement the method for disclosing mutual feelings, in accordance with some embodiments.

FIGS. 4A & 4B illustrate schematics of the mobile application to implement the method for disclosing mutual feelings, in accordance with some embodiments.

FIG. 5 illustrates a schematic of the mobile application to implement the method for disclosing mutual feelings, in accordance with some embodiments.

FIG. 6A & 6B illustrate schematics of the mobile application to implement the method for disclosing mutual feelings, in accordance with some embodiments.

FIGS. 7A & 7B illustrate schematics of the mobile application to implement the method for disclosing mutual feelings, in accordance with some embodiments.

FIGS. 8A-8C illustrate schematics of the mobile application to implement the method for disclosing mutual feelings, in accordance with some embodiments.

FIGS. 9A-9C illustrate schematics of the mobile application to implement the method for disclosing mutual feelings, in accordance with some embodiments.

FIG. 10 illustrates a schematic of the mobile application to implement the method for disclosing mutual feelings, in accordance with some embodiments.

FIGS. 11A-11C illustrate schematics of the mobile application to implement the method for disclosing mutual feelings, in accordance with some embodiments.

FIG. 12 illustrates a schematic of the mobile application to implement the method for disclosing mutual feelings, in accordance with some embodiments.

FIG. 13 illustrates a schematic of the mobile application to implement the method for disclosing mutual feelings, in accordance with some embodiments.

FIG. 14 illustrates a schematic of the mobile application to implement the method for disclosing mutual feelings, in accordance with some embodiments.

FIGS. 15A & 15B illustrate schematics of the mobile application to implement the method for disclosing mutual feelings, in accordance with some embodiments.

FIG. 16 illustrates a schematic of the mobile application to implement the method for disclosing mutual feelings, in accordance with some embodiments.

FIG. 17 illustrates a schematic of the mobile application to implement the method for disclosing mutual feelings, in accordance with some embodiments.

FIG. 18 illustrates a schematic of the mobile application to implement the method for disclosing mutual feelings, in accordance with some embodiments.

FIG. 19 illustrates a schematic of the mobile application to implement the method for disclosing mutual feelings, in accordance with some embodiments.

FIG. 20 illustrates a schematic of the mobile application to implement the method for disclosing mutual feelings, in accordance with some embodiments.

FIG. 21 illustrates a schematic of the mobile application to implement the method for disclosing mutual feelings, in accordance with some embodiments.

FIGS. 22A & 22B illustrate schematics of the mobile application to implement the method for disclosing mutual feelings, in accordance with some embodiments.

FIG. 23 illustrates a schematic of the mobile application to implement the method for disclosing mutual feelings, in accordance with some embodiments.

FIG. 24 illustrates a schematic of the mobile application to implement the method for disclosing mutual feelings, in accordance with some embodiments.

FIG. 25 illustrates a flow diagram for the method for disclosing mutual feelings, in accordance with some embodiments.

In accordance with common practice some features illustrated in the drawings cannot be drawn to scale. Accordingly, the dimensions of some features can be arbitrarily expanded or reduced for clarity. In addition, some of the drawings cannot depict all of the components of a given system, method or device. Finally, like reference numerals can be used to denote like features throughout the specification and figures.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

An aspect of the present application is to solve the problem of expressing sincere feelings and desires for shy and indecisive people who are afraid to admit their feelings in person for a variety of reasons: fear of losing a relationship, being rejected, misunderstood, ridiculed, etc. Disclosed methods enable users to express secret feelings and address them to an already familiar person (such as a friend, a spouse, children, parents, other relatives, etc.). Another aspect of the present disclosure enables users to express their feelings in a way that neither side's identity is revealed until the desire or feeling of both is mutual and directed at each other. The present disclosure is applicable in the circle of close acquaintances to help express the emotions, feelings and desires of a category of people with shy and indecisive character.

The present disclosure provides the choice of a specific feeling or desire that corresponds to the feeling of the sender. The present disclosure further notifies the recipient of a new feeling. Further, the present disclosure includes element of the game. That is, the presence of hints, or prompts, related to the sender's identity and added by the sender to hint at the recipient to identify him/her.

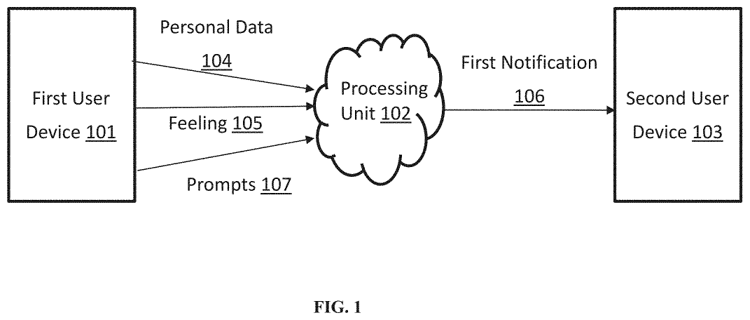

In some embodiments, a method for disclosing mutual feelings is disclosed. FIG. 1 illustrates a schematic of the method that is performed. In some embodiments, the method includes receiving, by a processing unit (PU) 102, one or more data about a first user from a first user device 101 associated with the first user. Prior to transmitting the personal information, the first user device 101 may encrypt the personal information. Upon receiving, the PU 102 may decrypt the personal information. The one or more data about a first user may include personal information 104 of the first user. The personal information 104 of the first user includes at least one of: a first name of the first user, a surname of the first user, a date of birth of the first user, a sex of the first user, a city of residence of the first user, a height of the first user, an eye color of the first user, a hobby of the first user, and a place of work of the first user.

In some embodiments, the method includes selecting, by the first user, a second user associated with the first user, followed by selecting, by the first user, a first feeling 105, from a plurality of feelings. The first feeling 105 is indicative of how the first user feels toward the second user. Subsequently, the method includes transmitting, by the PU, a first notification 106 to a second user device 103 associated with the second user. The first notification 106 is so transmitted that an identity of the first user is not revealed.

In some embodiments, the method further includes, prior to transmitting the first notification 106 to the second user device 103, adding, by the first user, one or more prompts 107 to the first feeling 105. The one or more prompts 107 may include at least one of: a phone number associated with the first user, a zodiac sign associated with the first user, an eye color associated with the first user, a city of residence associated with the first user, and a favorite music associated with the first user. The one or more prompts 107 may be locked for the second user to access. To unlock the one or more prompts 107, the second user may be asked to watch a paid advertisement associated with a third-party. Alternatively, in some embodiments, the second user pays to unlock the prompt 107.

In some embodiments, the step of selecting a second user includes accessing a contact list of the first device, and selecting the second user from the contact list.

In some embodiments, the method further includes, upon a selection of the second user, providing, by the first user, one or more information associated with the second user. The one or more information associated with the second user includes at least one of: a first name of the second user, a surname of the second user, and a phone number associated with the second user. Alternatively, in some embodiments, the method includes, upon a determination that at least one of the one or more information associated with the second user is incorrect, editing, by the first user, the at least one of the one or more information associated with the second user, and updating, by the PU, the contact list, by replacing the at least one of the one or more information associated with the second user with the edited at least one of the one or more information associated with the second user.

In some embodiments, the step of transmitting the first notification to second user device 103 is so performed that the first feeling is not revealed to the second user. In some embodiments, the PU 102 is located on a remote server. In some embodiments, the method is performed on an application program interface (API) on the first user device 101. A phone number associated with the first user may be used to identify the first user.

In some embodiments, the plurality of feelings includes one or more feelings indicative of at least one of: sympathy, love, sexual desire, breakup, reconciliation, and marriage proposal.

According to some embodiments, the method for disclosing mutual feelings includes, upon receiving the first notification by the second user device, selecting, by the second user, a third user associated with the second user; followed by selecting, by the second user, a second feeling, from a plurality of feelings. The second feeling is indicative of how the second user feels toward the third user. The method for disclosing mutual feelings further includes, upon determinations, by the PU, that the second user is a same as the third user, and the first feeling is a same as the second feeling, transmitting, by the PU, a second notification to the first user device and the second user device. The second notification is indicative of the first feeling. In some embodiments, the method for disclosing mutual feelings further includes prompting the first user and the second user to communicate via at least one of: the API, and a third-party user device application.

According to some embodiments, when the first user device 101 transmits data to the second user device 103 through the processing unit 102, data is encrypted by the first user device 101 and decrypted by the user device 101. Likewise, data is encrypted by the second user device 103 when the second user device 103 transmits any data and decrypted by the first user device 101 when the first user device 101 receives any data transmitted by the second user device 103. Data encryption and decryption provides added security to the system such that personal data 104, feeling 105 and prompts 107 are protected from others hacking into these data. Encryption and decryption can be performed on individual data such as personal data 104, or on any combination of data. For example, personal data 104 is encrypted along with feeling 105, while prompts 107 is not encrypted. In some embodiments all data is encrypted.

According to some embodiments, certain questions are sent to the second user device 103 by the first user device 101. Feelings 105 of the first user, transmitted by the first user device 101, are not disclosed to the second user on the second user device 103 if answers provided by the second user 103 do not match the answer expected by the first user device 101. The first user device 101 can set up an acceptable passing score for answering questions asked by the first user device 101. For example, the level can be anywhere from 50% to 100%. Depending upon the set passing criteria, feeling 105 can be revealed to the second user device 103.

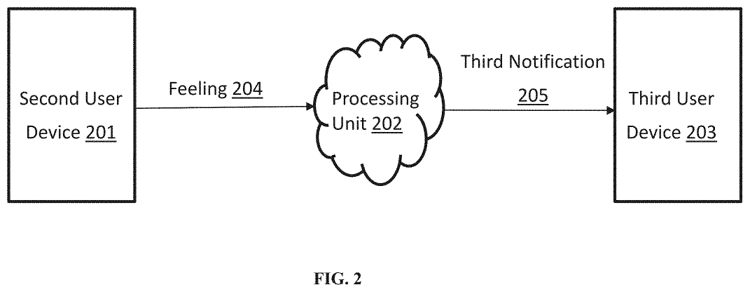

FIG. 2 illustrates the method for disclosing mutual feelings, in accordance with some embodiments. The method for disclosing mutual feelings may include, upon a determination, by the PU 202, that the second user is not same as the third user, transmitting, by the PU 202, a third notification 205 to the third user device 203. The third notification 205 is so transmitted that an identity of the second user is not revealed. In such embodiments, the feeling 204 is selected by the second user of the second device 201.

The present disclosure is a mutual desire for recognition in the secret feelings of two people who know each other. The feeling or desire is absolutely concrete and is kept in complete confidentiality. As a non-limiting example, the feeling can be: sympathy (e.g., a message stating “I'd like to date you”); love (e.g., a message stating “I love you”); sexual desire (e.g., a message stating “I want you”); reconciliation (e.g., a message stating “I'm sorry”); breakup (e.g., a message stating “Breakup”); marriage proposal (e.g., a message stating “Let's get married”); etc.

The method for disclosing mutual feelings allows the users to find out only their mutual, and secret, feelings; mutual desires to open these feelings; and a possibility of participation of a third party service (e.g., a mobile application such as “Feelo” a product of company Feelo Inc.) which acts as the intermediary between participants of recognition process.

The essence of the method for disclosing mutual feelings is that until both users (e.g., contacts) select each other from the contact list and send each other the same feeling, the users will not be disclosed to each other. In such a case, the first step towards recognition can be made by either of the users by sending the chosen one of the feelings offered by the system, which corresponds to his real desire.

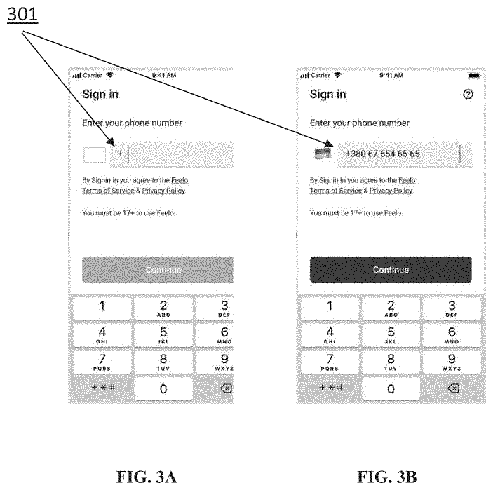

As an example, shown in FIGS. 3A & 3B, the first user, who has a secret feeling or desire for a friend or acquaintance (i.e., the second user), is registered in the system (i.e., via an API of a mobile application or via a website) using his mobile phone number 301. The mobile phone number may be in international format (i.e., country code+mobile operator/area code+phone number) is the user ID in the system.

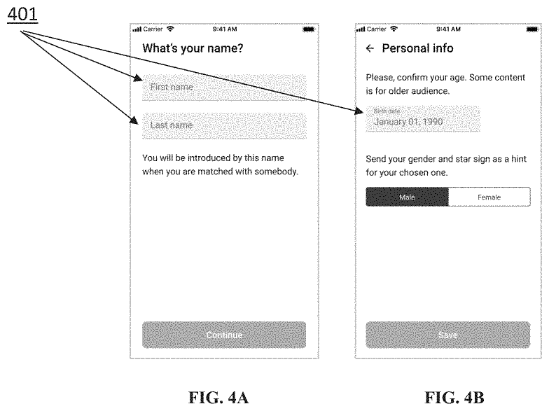

As shown in FIGS. 4A & 4B, after logging into the application, the first user fills in personal information 401 about himself, which can then be used as hints to the second user to identify the first user. First user's personal information 401 may consists a first name of the first user, a surname of the first user, a date of birth of the first user, a sex of the first user, (e.g., male or female), and can be extended to other information such as a city of residence of the first user, a height of the first user, an eye color of the first user, a hobby of the first user, a place of work of the first user, etc.

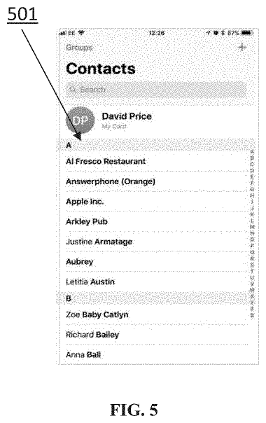

As shown in FIG. 5, after the login process is complete, the first user chooses from his contact book 501, the second user. The second user may be a friend or acquaintance of the first user to whom the first user has some secret feelings and wants those feelings to be shared. The second user does not need to be registered in the system (i.e., the mobile application or the website).

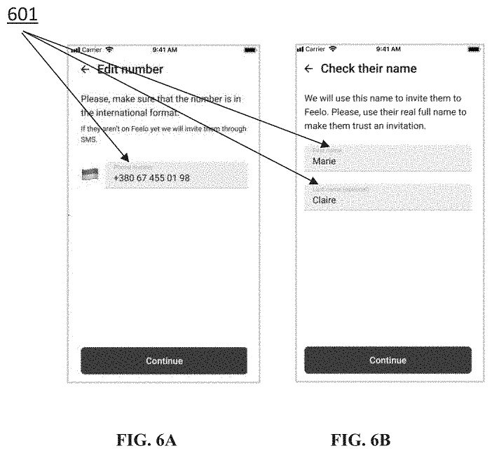

As shown in FIGS. 6A & 6B, after selecting the second user from the phone book of the first user, the first user is asked to confirm the contact details 601 of the second user (i.e., a first name of the second user, a surname of the second user, and a phone number of the second user). If one of the first name, last name, or phone number of the second user is not entered correctly in the contact book, the first user has the ability to edit and save information of the second user.

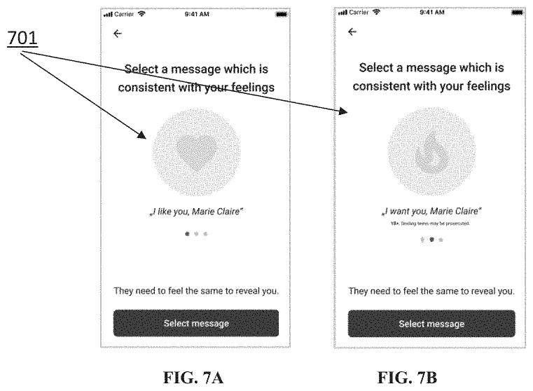

As shown in FIGS. 7A & 7B, after selecting the second user from the phone book of contacts, the first user is required to choose one of the feelings or wishes 701 offered by the application, which corresponds to his feelings towards the second user. The feelings 701 offered to users are defined and carry a specific message: sympathy (e.g., a message stating “I'd like to date you”); love (e.g., a message stating “I love you”); sexual desire (e.g., a message stating “I want you”); reconciliation (e.g., a message stating “I'm sorry”); breakup (e.g., a message stating “Breakup”); marriage proposal (e.g., a message stating “Let's get married”); etc.

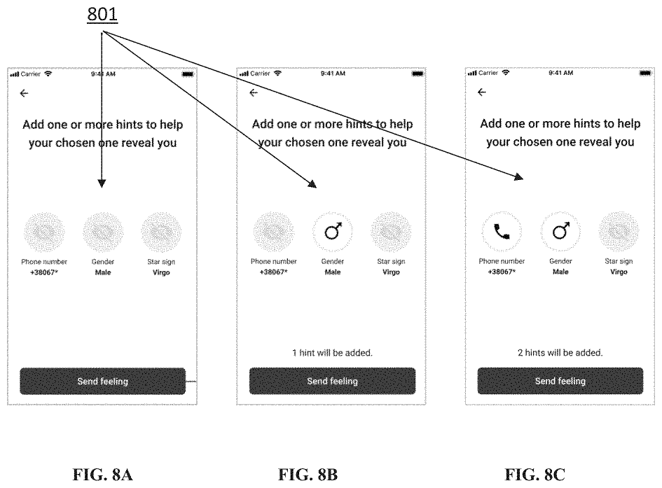

As shown in FIGS. 8A-8C, once the first user decides on the feeling and selected it, the first user can add one or more hints 801 (i.e., prompts) that the second user can buy for money or in the future for an equivalent offered cost of action (e.g., “viewing a paid ad” from advertisers). The prompts 801 that the first user can add to the selected feeling are based on the personal information of the first user, but do not directly disclose their identity. Examples of hints: a country code and phone operator of the first user, a zodiac sign of the first user, an eye color of the first user, a city of residence of the first user, a favorite music of the first user, etc.

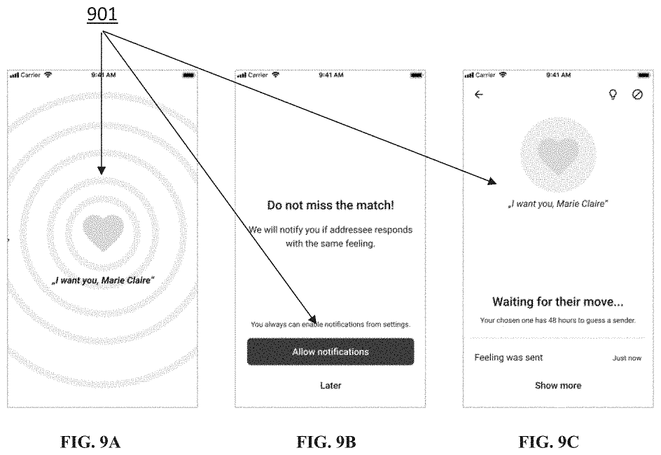

As shown in FIGS. 9A-9C, in addition to prompts, the first user can add the notification function 901 to the second user with a message that the second user will receive from the mobile application. The notification function increases the chances that the second user, when not registered with the mobile application, will be informed that a friend has confessed to him a sincere feeling or wish.

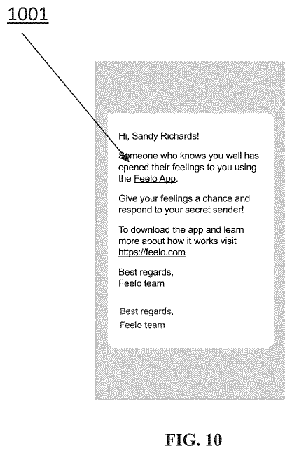

As shown in FIG. 10, regardless the prompts are added the first user can send a message 1001 to the second user.

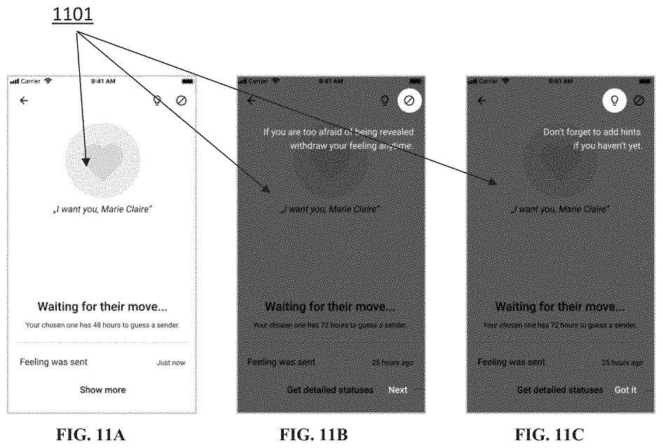

At the moment of sending, the message receives an identification number in the form of second user's phone number and is sent to the mobile application server (i.e., the processing unit). As shown in FIG. 11, the first user is shown the status of the message sent to the second user 1101 and also is given option to either add prompts or withdraw the message.

In some embodiments, the message remains on the application server (i.e., the PU) until the second user registers with the mobile application. The second user will receive an automatic message on behalf of the mobile application to their phone. The message may be sent to any messaging application with the following text: “Welcome,” “first name of the second user”, “last name of the second user”! Someone from your phone book, who knows you well—sincerely confessed to you one of the feelings (love, apology, date, etc.), and sent you a message to “name of the mobile application”. To find out what feeling was sent to you and to reciprocate, download the “name of the mobile application” application and register using your phone number as your ID for incoming message”.

When registering a new user (adding a new ID) the mobile application (the PU) searches for a message with an identical ID and if it finds one, sends it to the registered user. After a message with a sentiment created by the first user is sent to the second user, the first user sees a screen with a sent message that displays the following information: The second user's first and last name, the selected feeling (Icon and short description), and if the first user added hints/prompts, icons and description of added hints/prompts with the status “Available” and “hints” with the active possibility to “add”, As shown in FIG. 11.

An optional “Status Update” button enables the first user to receive notifications about the status of the message (e.g., the second user registrations in the mobile application, send a message to the second user, that the second user has read first user's message. Alternatively, once the first user and the second user are communicating via the mobile application, a “Reply” button is provided to for a message received from the other user. A “Cancel” button provides the possibility to “call back” a message with feeling sent to the selected contact.

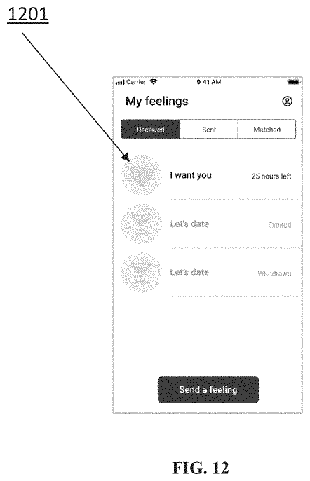

In some embodiments, if the second user is already registered with the mobile application, the message from the first user is sent to second user is stored in “My feelings” section 1201. If the second user is registered with the mobile application, a message from the first is sent to the number of the second user's account ID (i.e., a phone number in international format). After the message arrived at the second user's account, the second user receives a push notification about the new message, which is stored in “My Feelings” section and is displayed as “unread message”, as shown in FIG. 12.

The second user has several options for predefined actions: the second user can leave a message unread, or can open a message and leave it unanswered. An open message contains the following information: Hidden name of the first user, sense icon sent by the first user, name of the feeling sent by the first user, the one or more hints/prompts of the first user identification (if added by the first user) and the ability to “open” them (if applicable), and the “Answer” button. The second user can reply to the message.

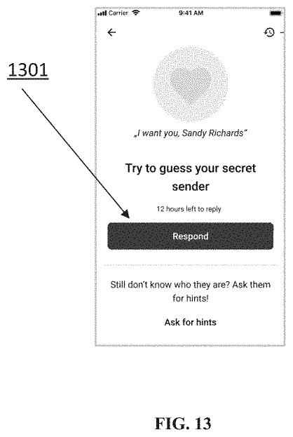

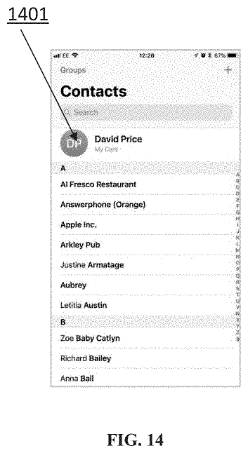

As shown in FIG. 13, by clicking on the “Respond” button 1301, the second user starts the script “Response”. At first the second user opens their contacts phone book 1401 where they can choose from a list of people to whom the second user feels the feeling received in the message (hoping that the sender of the message (the first user) is the chosen contact), as shown in FIG. 14.

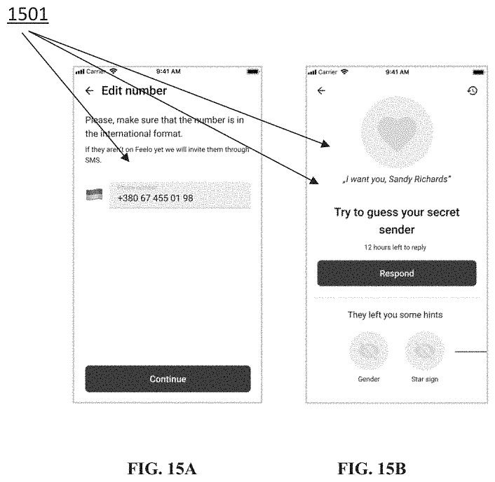

As shown in FIGS. 15A & 15B, the second user is asked to confirm the contact details 1501 of the sender whose name was guessed by the second user (i.e., a first name of the sender, a surname of the sender, and a phone number of the sender). If one of the first name, last name, or phone number of the sender is not entered correctly in the contact book, the second user has the ability to edit and save information of the sender.

After the contact is added, the second user opens a preformed message with a preset (i.e., previously received from the first user) emotion, as well as the selected recipient.

The script “Answer” assumes that the feeling (emotion or desire) cannot be changed by the second user and that it is automatically attached to the answer.

If the second user presses the “Reply” button, the message will be sent to the mobile application server (i.e., the PU). There are 2 options for further development:

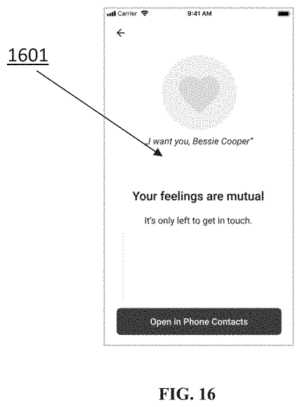

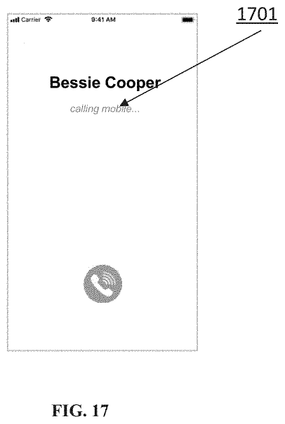

Option 1: as shown in FIG. 16, a message 1601 is sent to the second user indicating that the second user guessed the correct sender (i.e., the first user) and the feelings are the same. This option means that the first user and the second user have the same feelings or desires for each other. In this scenario, both users are notified by the push notification that their feelings are mutual (i.e., their names are revealed to each other 1701, as shown in FIG. 17), and both are encouraged to do the following choices:

A “Call” button appears on the screen that leads to a call with the first user.

A “Chat” button appears on the screen that opens the mobile application chat section inside the mobile application with the addition of the first user and the second user. Alternatively, any suitable messaging platform can be used to enable a chat between the first user and the second user.

A button “Return to “My Feeling” appears on the screen to exit the match notification.

Option 2: Two recipients selected by second user are not the ones by whom the message was sent (the first user), but a new user added to the system (a third user).

In this case, a new cycle of “relations” (i.e., messages) between the second user and the third user begins. In this scenario the second user has several choices:

A button “Send anyway” will appear pressing the button sends the feeling which was received by the second user. If the feeling that the second user received in a message is a paid (closed) feeling and was bought by the first user before it was sent, then answering this feeling (i.e., via the “Reply” button) is automatically available to the second user and they can send it. If the second user decides to send the same feeling to the third user (button “Send all the same”), the second user will have to buy it to send it (e.g., via one-time purchase or monthly subscription package) or choose one of the available feelings.

The second user can also choose other feeling and sends it to the “Feeling menu”, where the second user can choose one of the offered feelings and address it to the third user. The button “Cancel” enable the second user to return to the section “My feelings”.

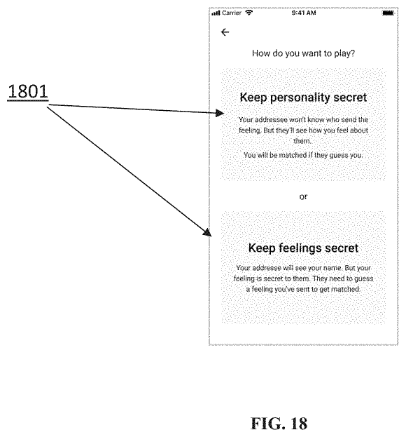

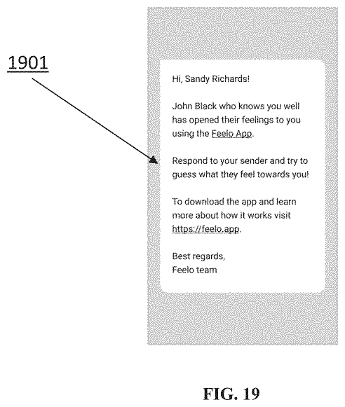

As shown in FIG. 18, the second user can keep the feeling for the third user secret 1801. If choose to send the feeling, the second user can send a message to the third user 1901 along with the feeling, as shown in FIG. 19.

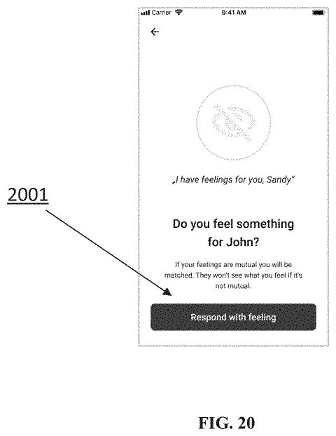

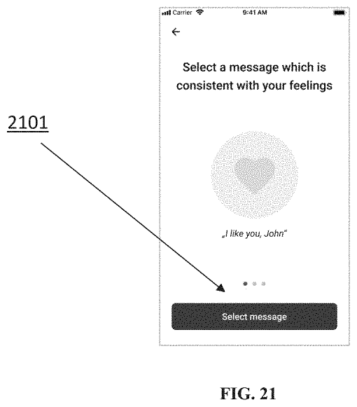

FIGS. 20 & 21 illustrate options provided to the second user to show their feeling toward the third user 2001, as shown in FIG. 20, or send a message to the third user 2101, as shown in FIG. 21.

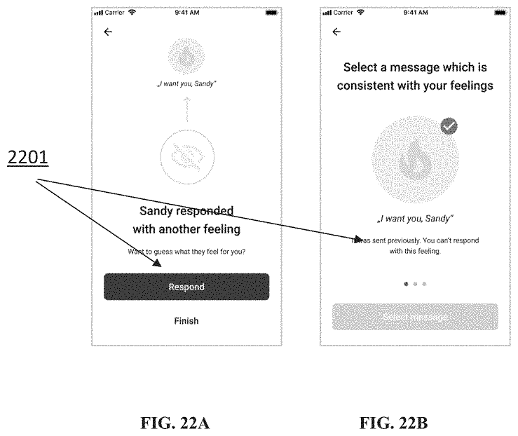

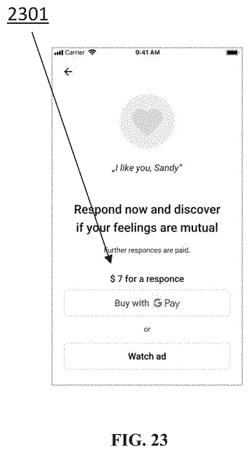

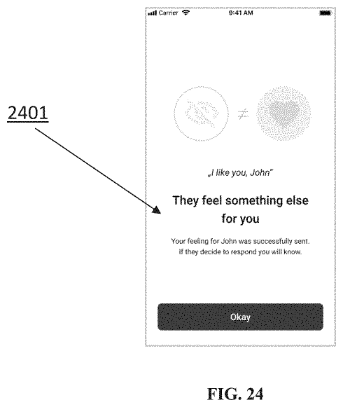

In some embodiments, the second user can reply another feeling and/or a message to the first user 2201, as shown in FIGS. 22A & 22B. In addition, the second user has the ability to purchase other options 2301 in responding to received feelings, as shown in FIG. 23. In such cases, the second user is shown a message confirming their feeling was sent to the intended recipient 2401, as shown in FIG. 24.

In some embodiments, the users may add media files, such as music, video, GIFs, PDFs, and other media files) to the messages and feelings. Additionally, the users can add one or more questions with multiple wrong answer choices and a single correct answer (like “tests”).

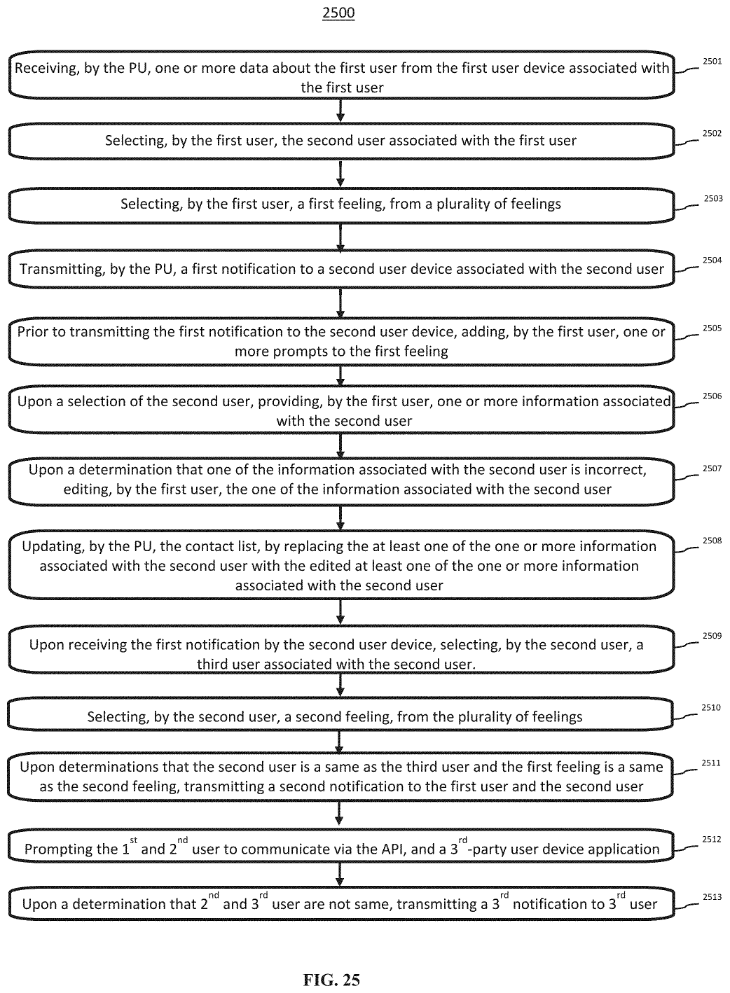

FIG. 25 illustrates a schematic of the method for disclosing mutual feelings, in accordance with some embodiments.

In some embodiments, the method for disclosing mutual feelings 2500 includes receiving, by the PU, one or more data about the first user from the first user device associated with the first user, as represented at block 2501. The one or more data about a first user includes personal information of the first user. The personal information of the first user includes at least one of: a first name of the first user, a surname of the first user, a date of birth of the first user, a sex of the first user, a city of residence of the first user, a height of the first user, an eye color of the first user, a hobby of the first user, and a place of work of the first user. The PU may be located on a remote server. Additionally, the method 2500 may be performed on an application program interface (API) on the first user device. In some embodiments, a phone number associated with the first user is used to identify the first user.

The method 2500 further includes, selecting, by the first user, the second user associated with the first user, as represented at block 2502.

The method 2500 further includes selecting, by the first user, a first feeling, from a plurality of feelings, as represented at block 2503. the plurality of feelings includes one or more feelings indicative of at least one of: sympathy, love, sexual desire, breakup, reconciliation, a marriage proposal, etc. Selecting a second user includes accessing a contact list of the first device, and selecting the second user from the contact list. The first feeling is indicative of how the first user feels toward the second user.

The method 2500 further includes transmitting, by the PU, a first notification to a second user device associated with the second user, as represented at bloc 2504. The first notification is so transmitted that an identity of the first user is not revealed. Further, transmitting the first notification to the second user device is so performed that the first feeling is not revealed to the second user.

As represented at block 2505, the method 2500 may include, prior to transmitting the first notification to the second user device, adding, by the first user, one or more prompts to the first feeling. The one or more prompts may include at least one of: a phone number associated with the first user, a zodiac sign associated with the first user, an eye color associated with the first user, a city of residence associated with the first user, and a favorite music associated with the first user. Further, the one or more prompts may be locked for the second user, and the second user may be required to watch a paid advertisement associated with a third-party to unlock the prompts. Alternatively, the second user may pay to unlock the prompt.

As represented at block 2506, the method 2500 may include upon a selection of the second user, providing, by the first user, one or more information associated with the second user. The one or more information associated with the second user includes at least one of: a first name of the second user, a surname of the second user, and a phone number associated with the second user.

Optionally, as represented at block 2507, the method 2500 may include upon a determination that at least one of the one or more information associated with the second user is incorrect, editing, by the first user, the at least one of the one or more information associated with the second user.

As represented at block 2508, the method 2500 may further include updating, by the PU, the contact list, by replacing the at least one of the one or more information associated with the second user with the edited at least one of the one or more information associated with the second user.

As represented at block 2509, the method 2500 may include upon receiving the first notification by the second user device, selecting, by the second user, a third user associated with the second user.

As represented at block 2510, the method 2500 may include selecting, by the second user, a second feeling, from a plurality of feelings. The second feeling is indicative of how the second user feels toward the third user.

As represented at block 2511, the method 2500 may include upon determinations, by the PU, that the second user is a same as the third user, and the first feeling is a same as the second feeling, transmitting, by the a second notification to the first user device and the second user device. The second notification is indicative of the first feeling.

As represented at block 2512, the method 2500 may include prompting the first user and the second user to communicate via at least one of: the API, and a third-party user device application.

As represented at block 2513, the method 2500 may include upon a determination, by the PU, that the second user is not same as the third user, transmitting, by the PU, a third notification to the third user. The third notification is so transmitted that an identity of the second user is not revealed.

It will also be understood that, although the terms first, second, etc. are, in some instances, used herein to describe various elements, these elements should not be limited by these terms. These terms are only used to distinguish one element from another. For example, a first device could be termed a second device, and, similarly, a second device could be termed a first device, without departing from the scope of the various described embodiments. The first device and the second device are both devices, but they are not the same device, unless the context clearly indicates otherwise.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including”, “comprises”, and/or “comprising”, when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

It should be appreciated that in the development of any actual embodiment (as in any development project), numerous decisions must be made to achieve the developers' specific goals (e.g., compliance with system and business-related constraints), and that these goals will vary from one embodiment to another. It will also be appreciated that such development efforts might be complex and time consuming but would nevertheless be a routine undertaking for those of ordinary skill in the art of image capture having the benefit of this disclosure.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method for disclosing mutual feelings, comprising:
receiving, by a processing unit (PU), one or more data about a first user from a first user device associated with the first user;
selecting, by the first user, a second user associated with the first user;
selecting, by the first user, a first feeling, from a plurality of feelings, wherein the first feeling is indicative of how the first user feels toward the second user, and
transmitting, by the PU, a first notification to a second user device associated with the second user, wherein the first notification is so transmitted that an identity of the first user is not revealed.

2. The method of claim 1, further comprising:
prior to transmitting the first notification to the second user device, adding, by the first user, one or more prompts to the first feeling.

3. The method of claim 2, wherein the one or more prompts comprises at least one of: a phone number associated with the first user, a zodiac sign associated with the first user, an eye color associated with the first user, a city of residence associated with the first user, and a favorite music associated with the first user.

4. The method of claim 2, wherein the one or more prompts are locked for the second user.

5. The method of claim 2, wherein the second user watches a paid advertisement associated with a third-party to unlock the prompt.

6. The method of claim 2, wherein the second user pays to unlock the prompt.

7. The method of claim 1, wherein selecting a second user comprises:
accessing a contact list of the first device, and
selecting the second user from the contact list.

8. The method of claim 1, further comprising:
upon a selection of the second user, providing, by the first user, one or more information associated with the second user.

9. The method of claim 8, wherein the one or more information associated with the second user comprises at least one of: a first name of the second user, a surname of the second user, and a phone number associated with the second user.

10. The method of claim 8, further comprising:
upon a determination that at least one of the one or more information associated with the second user is incorrect, editing, by the first user, the at least one of the one or more information associated with the second user, and
updating, by the PU, the contact list, by replacing the at least one of the one or more information associated with the second user with the edited at least one of the one or more information associated with the second user.

11. The method of claim 1, wherein the one or more data about a first user comprise personal information of the first user.

12. The claim of 11, wherein the personal information of the first user comprises at least one of: a first name of the first user, a surname of the first user, a date of birth of the first user, a sex of the first user, a city of residence of the first user, a height of the first user, an eye color of the first user, a hobby of the first user, and a place of work of the first user.

13. The method of claim 1, wherein transmitting the first notification to the second user device is so performed that the first feeling is not revealed to the second user.

14. The method of claim 1, wherein the PU is located on a remote server.

15. The method of claim 1, wherein the method is performed on an application program interface (API) on the first user device.

16. The method of claim 1, wherein a phone number associated with the first user is used to identify the first user.

17. The method of claim 1, wherein the plurality of feelings comprises one or more feelings indicative of at least one of: sympathy, love, sexual desire, breakup, reconciliation, and marriage proposal.

18. The method of claim 1, further comprising:
upon receiving the first notification by the second user device, selecting, by the second user, a third user associated with the second user;
selecting, by the second user, a second feeling, from a plurality of feelings, wherein the second feeling is indicative of how the second user feels toward the third user;
upon determinations, by the PU, that the second user is a same as the third user, and the first feeling is a same as the second feeling, transmitting, by the PU, a second notification to the first user device and the second user device, wherein the second notification is indicative of the first feeling.

19. The method of claim 18, further comprising:
prompting the first user and the second user to communicate via at least one of: the API, and a third-party user device application.

20. The method of claim 18, further comprising:
upon a determination, by the PU, that the second user is not same as the third user, transmitting, by the PU, a third notification to the third user, wherein the third notification is so transmitted that an identity of the second user is not revealed.
